(19) United States
(12) Patent Application Publication
(10) Pub. No.: US 2021/0114358 A1
(43) Pub. Date: Apr. 22, 2021

(54) MULTILAYER STRUCTURES, STAND-UP POUCHES, AND METHODS THEREOF

(71) Applicants: Braskem S.A., Camaçari (BR); TechnoSolutions Assessoria Ltda., Barueri (BR)

(72) Inventors: Wilson Andrade Paduan, Barueri (BR); Carlos Augusto Maia Faria, São Paulo (BR)

(73) Assignees: Braskem S.A., Camaçari (BR); TechnoSolutions Assessoria Ltda., Barueri (BR)

(21) Appl. No.: 17/077,691

(22) Filed: Oct. 22, 2020

Related U.S. Application Data
(60) Provisional application No. 62/924,657, filed on Oct. 22, 2019.

(51) Int. Cl. B32B 27/08; B32B 27/32; B32B 27/34; B32B 27/30; C09D 11/101

(52) U.S. Cl. CPC B32B 27/08; B32B 27/32; B32B 27/34; B32B 27/306; C09D 11/101; B32B 2323/046; B32B 2439/46; B32B 2250/24; B32B 2250/04; B32B 2250/05; B32B 2377/00; B32B 2329/04; B32B 2307/4023; B32B 2250/03

(57) ABSTRACT

A multilayer structure may include a polyethylene-based polymeric film comprising: a sealing layer; at least one middle layer; and a printing layer; and an external layer of ultraviolet or electron beam curable ink or varnish cured on the printing layer of the polyethylene-based polymeric substrate, wherein the multilayer structure has a thermal surface resistance such that when sealing bars are applied to the polyethylene-based polymeric film in cycles of sealing of no more than 2 seconds and at a temperature corresponding to the melting temperature of the polyethylene-based polymeric film, the sealing bars remain free of polymer.

### BACKGROUND

The use of flexible packaging for products, such as consumable products, has increased in recent years due to the unique marketing benefits and resource efficiency such packaging offers. For example, compared to conventional jars, cans, boxes, and the like, flexible packaging provide a unique appeal to consumers, who may be more apt to choose a product contained within over a product in a box or other packaging. Further, flexible packaging is more resource efficient that their traditional packaging counterparts.

An example of such flexible packaging is a stand-up pouch which is increasingly in widespread commercial use as packaging for consumer goods. These pouches are attractive to consumers and, when properly designed, make very efficient use of a minimal amount of polymeric material to prepare the package.

For example, stand-up pouches have a much higher product-to-packaging ratio than traditional packaging methods. Accordingly, manufacturers can reduce the resources and cost associated with packaging retail products (e.g., consumable products) while at the same time advertising their packaging as “green” in order to appeal to eco-conscious consumers. However, conventional stand-up pouches use a laminate of a layer of polyethylene terephthalate (PET) and a layer of polyethylene (PE), which makes the pouches difficult to recycle because of the different materials of construction.

Conventional stand-up pouches also suffer from certain drawbacks over traditional packaging methods and materials. One such drawback is the decreased stability that stand-up pouches exhibit over their jar, can, or box counterparts. For example, particularly in the case of solid, narrow products, a stand-up pouch may not exhibit appropriate stability to keep the product in an upright position on a shelf. Thus, if stand-up pouches are used for such products, the product may not sit upright on a shelf, or worse, may tip over completely, resulting in decreased visibility of the packaging and/or product to consumers.

Accordingly, there exists a continuing need for a stand-up pouch which exhibits the marketing and eco-friendly benefits of stand-up pouches while exhibiting improved stability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a multilayer structure that includes a polyethylene-based polymeric film comprising: a sealing layer; at least one middle layer; and a printing layer; and an external layer of ultraviolet or electron beam curable ink or varnish cured on the printing layer of the polyethylene-based polymeric substrate, wherein the multilayer structure has a thermal surface resistance such that when sealing bars are applied to the polyethylene-based polymeric film in cycles of sealing of no more than 2 seconds and at a temperature corresponding to the melting temperature of the polyethylene-based polymeric film, the sealing bars remain free of polymer.

In another aspect, embodiments disclosed herein relate to a stand-up pouch that includes a multilayer structure that includes a polyethylene-based polymeric film comprising: a sealing layer; at least one middle layer; and a printing layer; and an external layer of ultraviolet or electron beam curable ink or varnish cured on the printing layer of the polyethylene-based polymeric substrate, wherein the multilayer structure has a thermal surface resistance such that when sealing bars are applied to the polyethylene-based polymeric film in cycles of sealing of no more than 2 seconds and at a temperature corresponding to the melting temperature of the polyethylene-based polymeric film, the sealing bars remain free of polymer.

In another aspect, embodiments disclosed herein relate to a stand-up pouch that includes a plurality of panels, each panel being sealed to another panel and comprising: a polymeric substrate; and an external layer of ultraviolet or electron beam curable ink or varnish cured on a surface of the polymeric substrate, wherein the polymeric substrate with the ultraviolet or electron beam curable ink or varnish cured thereon meets at least one the following criteria:
a thermal surface resistance such that when sealing bars are applied to the plurality of panels in cycles of sealing of no more than 2 seconds and at a temperature corresponding to the melting temperature of the polymeric substrate, the sealing bars remain free of polymer;
withstands a printed face friction test for at least 30% more cold friction test cycles measured according to ASTM D5264 than the polymeric substrate without the ultraviolet or electron beam curable ink or varnish cured thereon; or
a chemical resistance to withstand direct contact with one or more of soybean oil, ethyl alcohol at 50% concentration in water or polyoxyethylene (9) nonylphenylether, in an immersion test for 24 hours.

In another aspect, embodiments disclosed herein relate to a method of forming a multilayer structure that includes forming a polyethylene-based polymeric film comprising: a sealing layer; at least one middle layer; and a printing layer; applying an ultraviolet or electron beam curable ink or varnish onto the printing layer; and irradiating the ultraviolet or electron beam curable ink or varnish with ultraviolet or electron beam radiation to form a multilayer structure that includes a polyethylene-based polymeric film comprising: a sealing layer; at least one middle layer; and a printing layer; and an external layer of ultraviolet or electron beam curable ink or varnish cured on the printing layer of the polyethylene-based polymeric substrate, wherein the multilayer structure has a thermal surface resistance such that when sealing bars are applied to the polyethylene-based polymeric film in cycles of sealing of no more than 2 seconds and at a temperature corresponding to the melting temperature of the polyethylene-based polymeric film, the sealing bars remain free of polymer.

In yet another aspect, embodiments disclosed herein relate to a method of forming a stand-up pouch that includes applying an ultraviolet or electron beam curable ink or varnish onto a polymeric substrate; irradiating the ultraviolet or electron beam curable ink or varnish with ultraviolet or electron beam radiation to form a multilayer structure; and sealing the multilayer structure to at least one other multilayer structure to form a stand-up pouch that includes a plurality of panels, each panel being sealed to another panel and comprising: a polymeric substrate; and an external layer of ultraviolet or electron beam curable ink or varnish cured on a surface of the polymeric substrate, wherein the polymeric substrate with the ultraviolet or electron beam curable ink or varnish cured thereon meets at least one the following criteria:
a thermal surface resistance such that when sealing bars are applied to the polymeric substrate in cycles of sealing of no more than 2 seconds and at a temperature corresponding to the melting temperature of the polymeric substrate, the sealing bars remain free of polymer;
withstands a printed face friction test for at least 30% more cold friction test cycles measured according to ASTM D5264 than the polymeric substrate without the ultraviolet or electron beam curable ink or varnish cured thereon; or
a chemical resistance to withstand direct contact with one or more of soybean oil, ethyl alcohol at 50% concentration in water or polyoxyethylene (9) nonylphenylether, in an immersion test for 24 hours.

Other aspects and advantages of the claimed subject matter will be apparent from the following description and the appended claims.

### BRIEF DESCRIPTION OF DRAWINGS

FIGS. 1-3 show various views of a stand-up pouch in accordance with one or more embodiments of the present disclosure.

FIG. 4 shows the impact on tensile strength in low density polyethylene with varying electron beam dose.

FIG. 5 shows the impact on elongation at break in low density polyethylene with varying electron beam dose.

FIG. 6 shows the impact on heat deformation in low density polyethylene with varying electron beam dose.

FIG. 7 shows absorption of electrons in accordance with one or more embodiments of the present disclosure.

FIG. 8 shows absorption of heat in accordance with one or more embodiments of the present disclosure.

### DETAILED DESCRIPTION

In one aspect, embodiments disclosed herein relate to films including multilayer structures used in packaging such as stand-up pouches. In particular, the films and multilayer structures may have an ultraviolet and/or electron beam curable ink or varnish cured on the surface thereof, which may not only provide graphic or finishes to the outer surface of the material, but may also result in an increase in the thermal, mechanical, and chemical resistance of the structure, thereby providing the material with properties that allow it function as a stand-up pouch, for example.

Stand-Up Pouches

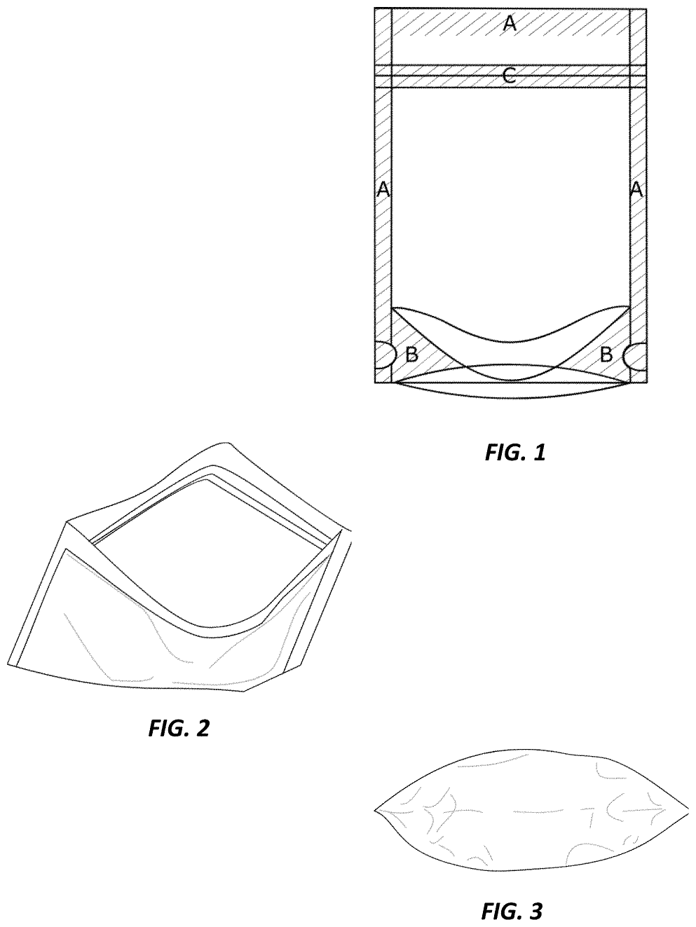

Stand-up pouches may have a variety of configurations, but a representative example of configuration is shown in FIGS. 1-3, showing a side view, top view, and bottom view, respectively, of an example stand-up pouch. The stand-up pouch 100 may be formed from a plurality of multi-layer structures, which may include a front panel 110, a back panel 120, and a bottom gusset 130 provided between the front panel 110 and back panel 120. The front panel 110 and back panel 120 may be sealed together along sealing regions A and C, and each of the front panel 110 and back panel 120 may be sealed to bottom gusset 130 at sealing regions B.

As those skilled in the art will appreciate, stand-up pouch 100 is configured to move between a substantially flat state as illustrated in FIG. 1 (i.e., where stand-up pouch 100 does not contain a product within) and a stand-up state (when stand-up pouch contains a product therein). In the substantially flat state, bottom gusset 130 may be folded along its center and sandwiched between front panel 110 and back panel 120.

Front panel 110, back panel 120, and bottom gusset 130 are sealed to one another along the perimeter of stand-up pouch 100 forming an open, enclosed interior. Accordingly, stand-up pouch 100 is configured to move between the substantially flat state and the stand-up state, wherein when in the stand-up state, it is capable of housing a product within the open, enclosed interior. Specifically, stand-up pouch 100 comprises sealed portions A, B, C, and unsealed portions (indicated by white space in FIG. 1).

The sealed portions A, B, C may be of sufficient thickness to create a sturdy, airtight, and/or liquid-tight seal between the enclosed, open interior and the outside of the stand-up pouch 100. It is envisioned that the sealed portions A, B, C may have the same dimensions or may have varying dimensions.

For example, in one or more embodiments, top sides of front panel 110 and back panel 120 may be sealed to one another after a product (e.g., a consumable product) is placed in the open, enclosed interior. In such an embodiment, a user (e.g., a consumer) may ultimately tear this top seal off to access a product within. Notches (such as, e.g., “V” shaped tear notches) or other tear guides may be provided on either or both sides to assist the user in tearing open the pouch.

Further, in one or more embodiments, the stand-up pouch may include both a resealable zipper or the like and a seal at the top side of stand-up pouch 100. For example, stand-up pouch 100 may be sealed along top side such that, e.g., a consumer must tear off a top seal to access the open, enclosed interior as discussed. However, stand-up pouch 100 may further include a resealable zipper disposed below the top seal (e.g., disposed closer to bottom side than the top seal) such that, after the consumer first accesses the open, enclosed interior by removing the top seal, the consumer may repeatedly open and close the stand-up pouch 100 using the resealable zipper. Those skilled in the art, given the benefit of this disclosure, will recognize many other configurations suitable for sealing or releasably sealing top side of stand-up pouch without departing from the scope of this disclosure. It is also envisioned that stand-up pouches may incorporate other features such a rigid nozzle, placed at the top of the pouch or on a front or back panel, through which the contents of the pouch may be emptied. Further, while the aforementioned figures show distinct panels which are sealed together, it is also envisioned that two or more portions of a single panel may alternatively be sealed together to form a flexible packing structure.

Film and Multilayer Structure

The panels of the stand-up pouches or other flexible packaging may be formed from a film or multilayer structure, which includes a polymeric substrate and a cured layer of ink or varnish applied to at least a portion of the polymeric substrate. In particular, the ink or varnish of the present disclosure may be the external layer on a surface opposite the surface to be sealed together (with another panel) to form the packaging materials. In particular, the ink or varnish may be the external printing without a protective layer such as a conventional protective polyester layer applied (or laminated) thereon. In one or more embodiments, the ink or varnish described herein may be at least applied to the portions (areas) of the polymeric substrate which will be sealed together, such as those described above in reference to the example stand-up pouch, but on the surface of the substrate opposite the surface being sealed. In one or more embodiments, the ink or varnish may be applied to the entire exposed surface of the polymeric substrate. Such inks or varnishes may optionally provide graphics or finishes to the package, and thus it may be desirable to have all, substantially all or a majority of the panel(s) coated with an external printing of the ink or varnish. Advantageously, these inks or varnishes may also provide the underlying polymeric substrate with the thermal, mechanical, or chemical resistance that allows for a polymeric substrate to be suitable for use in packaging without necessitating lamination of two materials with different melting points to accommodate heat resistance and sealing strength, such as conventionally achieved using a high temperature resistant external polyester film.

Ultraviolet or Electron Beam Curable Inks or Varnishes

Embodiments of the present disclosure may use an ultraviolet or electron beam curable ink or varnish applied and cured on at least a portion of a polymeric substrate (at least the areas that may be subjected to mechanical and thermal stresses, such as the sealing portions).

In one or more embodiments, the ultraviolet or electron beam curable ink or varnish may be a thermoset having a high thermal resistance, which may serve to protect the lower melt temperature polymeric substrate to which the ink or varnish is applied against mechanical and thermal stresses that may be experienced during construction and sealing of the material into packaging. The ultraviolet or electron beam curable inks or varnishes may behave as non-elastomeric fillers that do not compromise recyclability of the material (unlike laminating adhesives) and also do not require a high thermal and mechanical resistance film for structure protection or protection of printed inks (which conventionally occurs by lamination of a higher resistant film over the printed ink).

Examples of oligomers that may be used in the ink or varnish described herein may include, but are not limited to Bisphenol-A [4 EO] diacrylate, Polyethyleneglycol 200 diacrylate (PEG200DA), Polyethyleneglycol 400 diacrylate (PEG400DA), Polyethyleneglycol 600 diacrylate (PEG600DA), Tripropyleneglycol diacrylate (TPGDA), Bisphenol-A [4 EO] diacrylate, Neopentylglycol [2 PO] diacrylate (NPGPODA), Dipropyleneglycol diacrylate (DPGDA), Hexanediol [2 E0] diacrylate (HD2EODA, Hexanediol [2 PO] diacrylate (HD2PODA), Trimethylolpropane triacrylate (TMPTA), Trimethylolpropane [3 PO] triacrylate (TMP3POTA), Trimethylolpropane [3 EO] triacrylate (TMP3EOTA), Trimethylolpropane [6 EO] triacrylate (TMP9EOTA), Trimethylolpropane [9 EO] triacrylate (TMP9EOTA), Pentaerythritol triacrylate, Pentaerythritol tetraacrylate, Pentaerythritol [5 EO] tetraacrylate (PPTTA), Pentaerythritol [5 EO] tetraacrylate (PPTTA), and Dipentaerythritol Hexaacrylate (DPPA).

Other oligomers examples include, but are not limited to Acrylated epoxy soy oil (ESBOA), Bisphenol A epoxy diacrylate, Amine modified epoxy acrylate, Polyester diacrylate, Polyester triacrylate, Polyester tetraacrylate, Fatty acid modified polyester acrylates, Amine modified polyether acrylate, Aliphatic urethane diacrylate, Aliphatic urethane triacrylate, Aliphatic urethane tetraacrylate, Aromatic Urethane diacrylate, Aromatic Urethane triacrylate, and Aromatic Urethane tetraacrylate.

In embodiments using ultraviolet curable inks or varnishes, photoinitiators like 2-Hydroxy-2-methyl-1-phenylpropanone, bis-acylphosphine oxide (BAPO), 1-Hydroxycyclohexyl-phenyl ketone, 2-Methyl-1-[4-(methylthio)phenyl]-2-morpholinopropan-1-one, 2-Benzyl-2-(dimethylamino)-4′-morpholinobutyrophenone, 2,4,6-Trimethylbenzoyl-diphenyl phosphine oxide (TPO), Ethyl(2,4,6-Trimethylbenzoyl)-phenyl phosphinate (TPO Liquid), 2-Isopropyl thioxanthone, 2,4-Diethylthioxanthone, 4,4′bis(diethylamino) benzophenone, Piparazino based aminoalkylphenone, Polymeric Methyl Benzoylformate, Poly(ethylene glycol) bis(p-dimethylaminobenzoate, or Ethyl-4-(dimethylamino) benzoate may be present.

In one or more embodiments, additives such as wetting agents, acrylate silicon, fillers like precipitated silica, fumed silica, calcium carbonate, kaolin may be used. Further, waxes that are added to improve the coefficient of friction like polyethylene wax, paraffin wax, carnauba wax, etc. may also be used.

Further, for embodiments directed to inks, pigments may be present to provide the ink with color properties. For example, inks may include components like organic pigments like C.I Pigment Yellow 12, C.I Pigment Yellow 13, C.I Pigment Yellow 14, C.I Pigment Yellow 110, C.I Pigment Yellow 150, C.I Pigment Yellow 151, C.I Pigment Yellow 155, CI Pigment Red 48, C.I Pigment Red 48.1, C.I Pigment Red 48.2, C.I Pigment Red 48.3, C.I Pigment Red 48.4, C.I Pigment Red 57.1, C.I Pigment Red 122, C.I Pigment Red 168, C.I Pigment Red 184, C.I Pigment Blue 15.3, C.I Pigment Blue 15.4, C.I Pigment Black 7, C.I. Pigment Black 32, C.I. Pigment Green 7, C.I. Pigment Orange 5, C.I. Pigment Orange 13, C.I. Pigment Orange 34, C.I. Pigment Orange 36, C.I. Pigment Violet 23, Titanium dioxide, etc. Further, in one or more embodiments, dispersing agents, pigment synergists, etc, are among other additives that may be present in ink formulations.

In particular embodiments where a high degree of stiffness in the package is desired, stiffness or rigidity in the ink may be desirable. In such embodiments, a rigid, thermosetting ink or varnish may be used that may have visible cracks or fissures when the structure is subjected to a maximum elongation of 10% (the elongation being in any direction). Examples of such inks or varnishes may include high Tg low flexibility epoxy oligomers such as acrylated epoxy soy oil (ESBOA), bisphenol A epoxy diacrylate, or monomers such as TMPTA (trimethylol propane triacrylate), TPGDA (tripropyleneglycol diacrylate). In one or more embodiments, the inks or varnishes may have a Tg of at least 30° C.

On the other hand, one or more embodiments of the packaging may desire greater flexibility (and ability to withstand greater elongation) without resulting in aesthetically unacceptable defects. Moreover, in packaging that incorporates features such as nozzles or zippers, irregularities in the panels sealing around these features may be present, and at the time of sealing the panels, these features may result in greater elongation and contraction in the sealing areas. Thus, in one or more embodiments, the curable inks or varnishes may include flexible thermosetting inks or varnishes that only show a visible fissure, or crack upon not less than 10% elongation of the structure (the elongation being in any direction). Such flexible inks may be able withstand up to 20, 40, or 60% elongation without tears, fissures, or cracks. Examples of such inks or varnishes include polyester-based oligomers, polyurethane-based oligomers such as aliphatic urethane diacrylate or aliphatic urethane triacrylate, and/or ethoxylated or propoxylated monomers such as TMP3EOTA (trimethylolpropane [3E0] triacrylate), TMP9EOTA (trimethylolpropane [9E0] triacrylate), TMP3POTA (trimethylolpropane [3P0] triacrylate). In one or more embodiments, the inks or varnishes may have a Tg of less than 30° C.

Other example formulations of ink or varnish compositions include those described in, for example, U.S. Pat. Nos. 9,238,740, 9,404,000, and 8,729,147, each of which are incorporated by reference in their entirety.

In one or more embodiments, a water-based or solvent-based ink (not UV or electron beam curable) may be applied onto the polymeric substrate, and then a layer of ultraviolet or electron beam curable varnish may be applied atop the ink and subsequently cured. In this embodiment, as well as other embodiments using a single printing layer, it is envisioned that the varnish applied may include glossy, matte, textured, or soft touch varnishes.

In one or more embodiments, a flexographic, offset or rotogravure printing process may be compatible with ultraviolet or electron beam drying systems to apply and then cure the inks or varnishes. In particular embodiments, rotogravure may be used when printing with water or solvent based inks, followed by varnishing with an electron beam curable varnish.

In order to trigger the curing of the curable ink or varnish, an intensity of electron beam ranging from 20 kGv to 100 kGv, or an ultraviolet radiation ranging from 25 mJ to 400 mJ may be used. In one or more embodiments, an intensity of electron beam may have a lower limit of any of 20, 30, 40, 50, or 60 kGv, and an upper limit of any of 40, 50, 60, 70, 80, 90, or 100 kGv, where any lower limit can be used in combination with any upper limit. In one or more embodiments, an ultraviolet radiation may have a lower limit of any of 25, 50, 75, 100, 150, or 200 mJ, and an upper limit of any of 200, 250, 300, 350, or 400 mJ, where any lower limit can be used in combination with any upper limit.

Polymeric Substrate

As mentioned above, conventional packaging may use multiple types of materials, resulting in the materials lacking recyclability. However, in one or more embodiments of the present disclosure, the polymeric substrate may at least substantially formed from a single material (or combination of different types of a single material, i.e., one or more polyethylenes, etc. having different physical, chemical or optical properties such as, but not limited to: molecular weight, density, melt index, sealing temperature, melting temperature, crystallinity among other properties) on which the ink or varnish is applied, thereby improving the recyclability of the structure without sacrificing properties. In one or more embodiments, the polymeric substrate may be selected from polyethylene, polypropylene, polyester (such as but not limited to polylactic acid), polyamide, or an ethylene vinyl alcohol copolymer.

However, it is envisioned that polymeric substrates may include blends of polyolefins, such as at least 70 wt % of at least one polyethylene blended with up to 30 wt % of at least one polypropylene, or at least 70 wt % at least one polypropylene blended with up to 30 wt % of at least one polyethylene. It is also envisioned that a multilayer film having layers of one or more polyethylene and one or more layers of polypropylene may be used with such 70/30 or 30/70 weight percentages. In another embodiment, a multilayer film of at least 90 wt % or at least 95 wt % of the multilayer film of at least one polyethylene in combination up to 10 wt % or up to 5 wt % of the multilayer film of at least one ethylene vinyl alcohol may be used. This multilayer film may be recyclable while also possessing a high oxygen barrier (preventing the oxidation of oxygen-sensitive foods such as oils). For example, in such embodiment, a barrier layer of ethylene vinyl alcohol may be used in combination with one or more layers of polyethylene while maintaining recyclability. It is further envisioned that in an embodiment, a barrier layer of polyamide used in combination with one or more layers of at least one polyethylene may be used.

In one or more embodiments, the at least one polyethylene used in the present disclosure may include at least one selected from the group consisting of high density polyethylene (HDPE), low density polyethylene (LDPE) and/or linear low density polyethylene (LLDPE), or combinations thereof.

While one or more embodiments may use a petrochemical HDPE, LDPE, and/or LLDPE resin in the polymeric substrate, in one or more particular embodiments, polyethylene virgin resin may be bio-based.

Biobased ethylene polymers (HDPE, LDPE, and/or LLDPE) in accordance with the present disclosure may include polyolefins containing a weight percentage of biologically derived monomers. Biobased ethylene polymers and monomers that are derived from natural products may be distinguished from polymers and monomers obtained from fossil-fuel sources (also referred to as petroleum-based polymers). Because biobased materials are obtained from sources that actively reduce CO₂ in the atmosphere or otherwise require less CO₂ emission during production, such materials are often regarded as “green” or renewable. The use of products derived from natural sources, as opposed to those obtained from fossil sources, has increasingly been widely preferred as an effective means of reducing the increase in atmospheric carbon dioxide concentration, therefore effectively limiting the expansion of the greenhouse effect. Products thus obtained from natural raw materials have a difference, relative to fossil sourced products, in their renewable carbon contents. This renewable carbon content can be certified by the methodology described in the technical ASTM D 6866-18 Norm, “Standard Test Methods for Determining the Biobased Content of Solid, Liquid, and Gaseous Samples Using Radiocarbon Analysis”. Products obtained from renewable natural raw materials have the additional property of being able to be incinerated at the end of their life cycle and only producing CO₂ of a non-fossil origin.

Examples of biobased ethylene-based polymers may include polymers generated from ethylene derived from natural sources such as sugarcane and sugar beet, maple, date palm, sugar palm, sorghum, American agave, starches, corn, wheat, barley, sorghum, rice, potato, cassava, sweet potato, algae, fruit, citrus fruit, materials comprising cellulose, wine, materials comprising hemicelluloses, materials comprising lignin, cellulosics, lignocelluosics, wood, woody plants, straw, sugarcane bagasse, sugarcane leaves, corn stover, wood residues, paper, polysaccharides such as pectin, chitin, levan, pullulan, and the like, and any combination thereof.

Biobased materials may be processed by any suitable method to produce ethylene, such as the production of ethanol from sugarcane, and the subsequent dehydration of ethanol to ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Biologically sourced ethanol, known as bio-ethanol, used to produce ethylene may be obtained by the fermentation of sugars derived from cultures such as that of sugar cane and beets, or from hydrolyzed starch, which is, in turn, associated with other materials such as corn. It is also envisioned that the biobased ethylene may be obtained from hydrolysis-based products from cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

In one or more embodiments, biobased products obtained from natural materials may be certified as to their renewable carbon content, according to the methodology described in the technical standard ASTM D 6866-18, “Standard Test Methods for Determining the Biobased Content of Solid, Liquid, and Gaseous Samples Using Radiocarbon Analysis.”

Biobased resins (including biobased HDPE, biobased LDPE, and biobased LLDPE) in accordance with the present disclosure may include an ethylene-containing resin having biobased carbon content as determined by ASTM D6866-18 Method B of at least 5%, or having a lower limit of any of 5%, 10%, 15%, 25%, 40% and 50% and an upper limit selected from any of 60%, 75%, 90%, 98%, and 100%, where any lower limit may be combined with any upper limit. Further, it is also noted that another polymer derived from renewable sources which may be used in one of more embodiments is polylactic acid, which in addition to being formed from renewable sources is also compostable.

In one or more embodiments, one or more of the ethylene-based polymer compositions includes an HDPE and/or LDPE and/or LLDPE (each of which may optionally be biobased) that has a melt index measured according to ASTM D1238 at 190° C./2.16 kg ranging from 0.5 to 2 g/10 min. In particular, the melt index may have a lower limit ranging from any of 0.25, 0.5, or 0.75 g/10 min to an upper limit ranging from any of 0.4, 0.5, 1 or 2 g/10 min, where any lower limit can be used in combination with any upper limit.

In one or more embodiments, one or more of the ethylene-based polymer compositions includes an HDPE (which may optionally be biobased) that has a density measured according to ASTM D 792 ranging from 0.950 to 0.965 g/cm³. In particular, the density may range from a lower limit of any of 0.940, 0.950, and 0.955 g/cm³ to an upper limit of any of 0.955, 0.960, 0.965, and 0.970 g/cm³, where any lower limit can be used in combination with any upper limit.

In one or more embodiments, one or more of the ethylene-based polymer compositions includes an LDPE and/or LLDPE (which may optionally be biobased) that has a density measured according to ASTM D 792 ranging from 0.910 to 0.930 g/cm³. In particular, the density may range from a lower limit of any of 0.910, 0.916, and 0.920 g/cm³, to an upper limit of any of 0.920, 0.925, 0.930, 0.935, and 0.940 g/cm³, where any lower limit can be used in combination with any upper limit.

While one or more embodiments may use a single layer polymeric substrate, it is also envisioned that a plurality of layers may be used, such as 2, 3, 5, or 7 layers. When using multilayer polymeric substrates, one or more embodiments may use co-extruded multilayer substrates, while other embodiments may use laminated multilayer substrates, which may be laminated using water-based, solvent-based or even solvent-free adhesives. In one or more embodiments, while the polymeric substrate may be laminated, the ink or varnish applied and cured on the polymeric substrate is the external layer, without a further lamination or film applied thereto. In embodiments having a thickness of less than 80 microns, a laminated structure may be particularly desirable, where a first layer(s) may be laminated to a second layer(s) having the ultraviolet or electron beam curable ink or vanish already cured thereon. In such embodiment, the first layer(s) forms at least the sealing layer, and the second layer(s) forms at least the printing layer.

In particular embodiments, a polymeric substrate may include a multilayer film having at least three layers: a sealing layer (for sealing to another film), a middle layer, and a printing layer (on which the inks or varnishes are applied and cured). For example, in one or more embodiments, a sealing layer may form from 10 to 30% of the total thickness of the polymeric substrate and may be formed from 60 to 95 wt % of an LLDPE (specifically, for example, a metallocene LLDPE) and 5 to 40 wt % LDPE. A middle layer may form 40 to 80% of the total thickness of the polymeric substrate and may be formed from to 50 to 100 wt % of HDPE, and up to 50 wt % of LLDPE (specifically, for example, a metallocene LLDPE). A printing layer may form from 10 to 30% of the total thickness of the polymeric substrate and may be formed from 50 to 100 wt % of HDPE, and up to 50 wt % of LLDPE (specifically, for example, a metallocene LLDPE). The wt % presented in this paragraph are based in the total weight of each of the layers in the multilayer film structure.

In one or more embodiments, a polymeric substrate may include a multilayer film having at least five layers: a sealing layer (for sealing to another film), a first middle layer, a barrier layer, a second middle layer, and a printing layer (on which the inks or varnishes are applied and cured). For example, in one or more embodiments, a sealing layer may form from 10 to 20% of the total thickness of the polymeric substrate and may be formed from 60 to 95 wt % of an LLDPE (specifically, for example, a metallocene LLDPE) and 5 to 40 wt % LDPE. A first middle layer may form from 15 to 30% of the total thickness of the polymeric substrate and may be formed from to 50 to 100 wt % of HDPE, and up to 50 wt % of LLDPE (specifically, for example, a metallocene LLDPE). A barrier layer may form from 5 to 20% of the total thickness of the polymeric substrate and may be formed from ethylene vinyl alcohol, or from 5 to 10 wt % in more particular embodiments. A second middle layer may form from 15 to 30% of the total thickness of the polymeric substrate and may be formed from to 50 to 100 wt % of HDPE, and up to 50 wt % of LLDPE (specifically, for example, a metallocene LLDPE). A printing layer may form 10 to 20% of the total thickness of the polymeric substrate and may be formed from 50 to 100 wt % of HDPE, and up to 50 wt % of LLDPE (specifically, for example, a metallocene LLDPE). The wt % presented in this paragraph are based in the total weight of each of the layers in the multilayer film structure.

Further, polymer substrates may be formed from polymer compositions that may include fillers and additives that modify various physical and chemical properties when added to the polymer composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents.

Multilayer Structure Properties

In one or more embodiments, the multilayer structure may have a thickness ranging from 50 to 250 microns, such as a lower limit of any of 50, 60, 70, 80, or 100 microns, and an upper limit of any of 120, 150, 200, or 250 microns, where any lower limit can be used in combination with any upper limit. In particular embodiments, a stand-up pouch may be constructed from panels of a multilayer structure having a thickness ranging from 70 to 250 microns. Further, in embodiments using laminated structures, the laminated films may have a thickness ranging from 50 to 100 microns.

As mentioned above, the application and curing of the ultraviolet or electron beam curable ink or varnish on the surface of the polymeric substrate may provide for an improvement in thermal, mechanical, and/or chemical resistance of the surface, as compared to the polymeric substrate without the cured ink or varnish. In one or more embodiments, the cured ink or varnish thereon may result in a differential of properties across a thickness of the polymeric substrate, such that the printing surface of the polymeric substrate may exhibit an improved property, in particular relative to a sealing surface.

For example, an increased thermal resistance may be demonstrated during sealing of panels of the multilayer substrate or film to one another. During such sealing operation, sealing bars may be used to heat and seal the panels together. While the sealing bars may heat the polymeric substrate to a temperature at which the polymeric substrate will begin to melt (and seal together), the external printing layer of thermoset ink or varnish (at least in the regions corresponding to the location of the sealing bars) may change the thermal properties of the printing surface of the film such that the ink or varnish may prevent the sealing bars from being contaminated by molten polymer. In one or more embodiments, the thermal resistance afforded by the UV or EB curable ink or varnish (once cured onto the polymeric substrate) may increase the thermal resistance or protection of the polymeric substrate to a sufficient extent that the sealing bars are able to be kept in contact with a polymeric substrate for sealing cycles of up to 2 min without polymer melting onto the sealing bars (i.e., the sealing bars remain free of polymer), as compared to a polymeric substrate without the UV or EB cured thereon.

In one or more embodiments, the thermal stability may be an increase in the thermal resistance of the polymeric substrate during the process of forming the stand-up pouch that allows for increasing the processing temperature by at least 20° C., at least 40° C., or at least 60° C. as over the melting temperature of the polymeric substrate without the ink or varnish cured thereon.

Similarly, the presence of the thermoset ink or varnish may also serve to protect the multilayer structure or film from scratches, by increasing the scratch and rub resistance. In one or more embodiments, the cured ink or varnish may increase the surface resistance such that the multilayer structure or film withstands a friction test for at least 30% more cycles of a cold friction test measured according to ASTM D5264, as compared to the polymeric substrate without the ink or varnish cured thereon. In more particular embodiments, the present films having a cured ink or varnish thereon may be able to withstand a lower limit of any of 30, 50, 70, or 100% more cycles, or an upper limit of any of 100, 125, 150, 175, or 200% more cycles, where any lower limit can be used in combination with any upper limit.

EB curing causes a polymerization or 3D reticulation or scission over polymer molecules. In one or more embodiments, polymers may be reticulated with increasing in molecular size and consequently improvements in some properties, which may result in increasing in melting points, sealing temperature, tensile strength and, at the same time, decreasing in elongation, elongation at rupture and flexibility. This effect may be particularly present using polyethylene. Polyethylene may demand more energy to undergo physical state transformation than to be heat up itself. These two different states of heat are acknowledged as sensible heat (heat perceived by generating an increasing in temperature) and latent heat (heat consumed to promote modification of physical state without change in temperature). As example, sensible heat of polyethylene is 1.55 J/g° C. and the latent heat is 164 J/g. Thus, to heat each gram of PE from 25° C. to an average melting temperature of medium density PE of about 130° C. consumes around 162.75 J. However, beyond this, if heat is still supplied, to up to 164 J/g in an adiabatic environmental, no change in the temperature will be observed, but the physical state will change from solid to liquid (viscous).

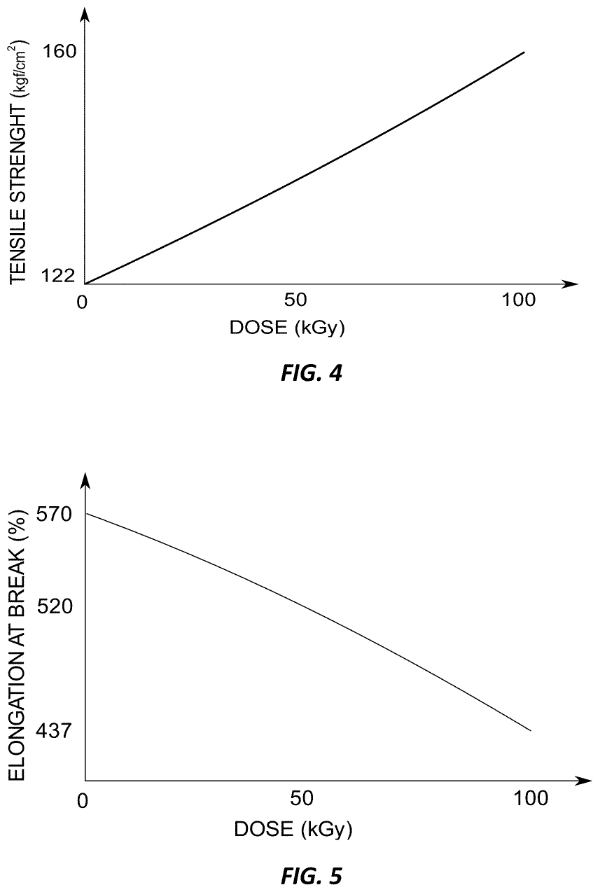

Referring now to FIGS. 4-6, FIGS. 4-6 exemplifies the impact of electron beam irradiation on the mechanical properties of a low density polyethylene sample, in particular the tensile strength and elongation at breaks, both of which are measured according to ASTM D638. As shown in FIG. 4, FIG. 4 demonstrates a correlation between electron beam dose and an increase in tensile strength, at a rate of about 0.4 kgf/cm² per kGV between 0 kGv or 100 kGv. This improvement in the mechanical resistance of the polyethylene caused by 3D polymerization due to EB radiation on a film may also provide a benefit for stability of the overall packaging during stand-up pouch cycle formation.

Referring now to FIG. 5, FIG. 5 shows that elongation at break of LDPE reduces at a rate near 1.33% per kGy of dose in the interval between 0 kGy to 100 kGy, from 570% to 437%, a total variation of 23% in the total elongation. Elongation at break is a property related to the elasticity of polyethylene. The elasticity is even more pronounced at higher temperatures and the tendency of EB radiation to decrease the elasticity of PE is very beneficial to the production process of the stand-up pouch, since the less elasticity preserves the dimensional stability of the stand-up pouch during production.

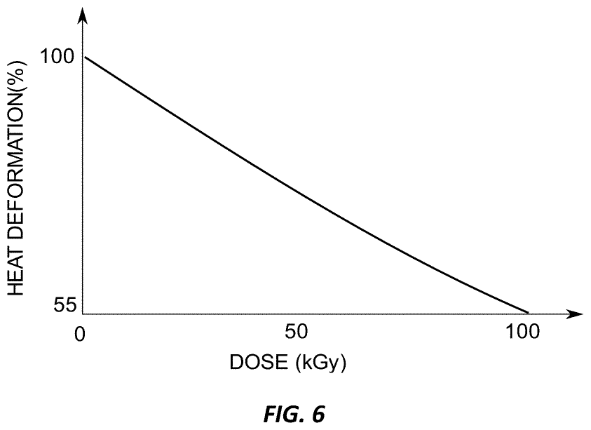

Referring now to FIG. 6, FIG. 6 shows the heat deformation of LDPE with EB dose. In the heat deformation test, a sample of LDPE with 3.0×1.5 cm×2 mm of thickness is submitted to a traction of 1 kg in an oven at 120° C. in a total of pre heating before adding weight of 30 minutes and more 30 minutes after the weight is added. The variation on the thickness in % is considered the heat deformation. The value of non-irradiated LDPE is the standard 100% and the decreasing in the reduction of thickness with increased dose is very significant. Thus, the present inventors have found that irradiation with electron beams may significantly improve the thermal strength resistance of the polymeric substrate, such as the low density polyethylene shown in FIGS. 4-6.

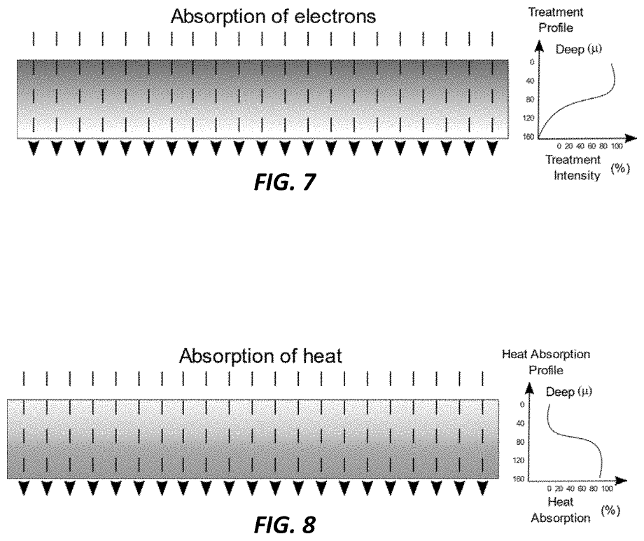

As shown FIG. 7, during electron beam curing of the ink or varnish, the electrons are absorbed into the polymeric substrate, but with decreased absorption progressed deeper into the polymeric substrate. That electron beam radiation may increase the melting temperature, sealing temperature and tensile strength of the polymeric substrate such as polyethylene. While electron beam radiation is highly capable of increasing the melting point of polyethylene by polymerization and cross linking of molecules, the total amount of heat needed to reach the melting point of polyethylene from room temperature and the total amount of heat to melt the polyethylene at the melting temperature are very close. The present inventors have found that sum of those two characteristics generates a unique properties when polyethylene is treated by electron beam radiation: the first microns of the film at the printing surface increases its melting temperature and as a result of this, the consumption of incoming heat is reduced in the first part of the film and saves the heat for the more deep parts of the film where the sealing process will be take place. Specifically, while electron absorption is highest at the surface, heat absorption increases with increasing depth, as shown in FIG. 8. This result is due to an increase in melting temperature within the upper portion of the substrate, therefore the heat is absorbed deeper in the substrate, where the sealing of the structure will take place.

Thus, not only does the ultraviolet or electron beam cure the ink and result in increased thermal resistance of the polymeric substrate, but the polymeric substrate with EB radiation may also have greater mechanical stability, not simply resulting from increased tensile strength and reduced elongation at break, but also because the energy concentration occurs deeper in the polymeric substrate adjacent the sealing, which also helps avoid cracks in the printing side of the structure.

Thus, in one or more embodiments, the ink or varnish, upon curing, may provide mechanical strength to the polymeric substrate surface to withstand printed face x printed face friction tests for at least 30% more cycles in a cold friction test according to ASTM D5264, as compared to the same polymer surface without inks or varnishes discussed herein. In one or more embodiments, the film may withstand at least 50%, 100% and 200% more cycles in cold friction test than the same polymer without the ink and varnish protection.

Thus, in one or more embodiments, after EB irradiation, the presently descried films may have an increased tensile strength of, at least 10% more than the same structure before the EB irradiation. In one or more embodiments the structure may have an increasing in the tensile strength of 15%, 20%, 25% and 30%.

Thus, in one or more embodiments, after EB irradiation, the presently described films may have an decrease in elongation at break of, at least 5% less than the same structure before the EB irradiation. In one or more embodiments the structure may have a decrease in the tensile strength of 10%, 15%, 15%, 20% and 25% as compared to the same structure before the EB irradiation.

Further, given that the structure is envisioned for use in packaging, the structure must also be resistant to the product to be packaged therein. In one or more embodiments, the ink or varnish, upon curing, may provide chemical resistance to the polymeric substrate such that it may withstand direct contact with the product to be packaged in a cold 24 h product immersion test without exhibiting mechanical displating, flaking, discoloration or embrittlement. While such tests are conventionally performed on the ultimate product to be carried by the stand-up pouch, in accordance with the present disclosure, the immersion tests may be performed on example products. Specifically, such immersion test may include immersing samples of the UV or EB cured ink or varnish on the polymeric substrate, immersions bath for 24 hours at 25° C. The samples may be tested in baths of one or more of soybean oil, ethyl alcohol at 50% concentration in water or a liquid detergent, specifically polyoxyethylene (9) nonylphenylether (sold under tradename IGEPAL® CO-630). After 24 hours, the samples are visually inspected. A “pass” may be assigned if the sample exhibits no mechanical displating, flaking, discoloration, or embrittlement in any one of the three baths. In one or more embodiments, samples of the films described herein may “pass” an immersion test in each of these three baths (one sample per bath).

In one or more embodiments, the film may have a gloss at a 45° angle, measured according to ASTM D2457 ranging that is greater than 5 (matte) up to 100 (gloss) points.

In one or more embodiments, the film may have an Elmendorf tear strength, measured according to ASTM D 1922, that is greater than 30 gF in machine direction (MD) and greater than 100 gF in transversal direction (TD).

In one or more embodiments, the film may have a tensile modulus at 1% secant, measured according to ASTM D 882, of greater than 350 MPa in machine direction (MD) and greater than 400 MPa in transversal direction (TD).

In one or more embodiments, the film may have a tensile strength at yield, measured according to ASTM D 882, of greater than 8 MPa in machine direction and greater than 8 MPa in transversal direction.

In one or more embodiments, the film may have a tensile strength at break, measured according to ASTM D 882, of greater than 40 MPa in machine direction (MD) and greater than 30 MPa in transversal direction (TD).

In one or more embodiments, the film may have an Impact Resistance of Plastic Film by the Free-Falling Dart Method, measured according to ASTM D1709-01, of greater than 80 gf.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A multilayer structure, comprising:
a polyethylene-based polymeric film comprising:
a sealing layer;
at least one middle layer; and
a printing layer; and
an external layer of ultraviolet or electron beam curable ink or varnish cured on the printing layer of the polyethylene-based polymeric substrate, wherein the multilayer structure has a thermal surface resistance such that when sealing bars are applied to the polyethylene-based polymeric film in cycles of sealing of no more than 2 seconds and at a temperature corresponding to the melting temperature of the polyethylene, the sealing bars remain free of polymer.

2. The multilayer structure of claim 1, wherein the sealing layer comprises 5 to 40 wt % of low density polyethylene and 50-95 wt % of linear low density polyethylene; wherein the at least one middle layer comprises up to 50 wt % of linear low density polyethylene and 50-100 wt % of high density polyethylene; and wherein the printing layer comprises up to 50 wt % of linear low density polyethylene and 50 to 100% of high density polyethylene.

3. The multilayer structure of claim 1, the polyethylene-based polymeric film further comprises a barrier layer between at least two middle layers, wherein the barrier layer comprises ethylene vinyl alcohol or polyamide.

4. The multilayer structure of claim 1, wherein the cured ultraviolet or electron beam curable ink or varnish has a degree of elongation showing a visible crack upon not less than 10% elongation of the multilayer structure.

5. The multilayer structure of claim 1, wherein the at least a portion of the polyethylene-based polymeric film exhibits a biobased carbon content as determined by ASTM D6866-18 Method B of at least 50%.

6. The multilayer structure of claim 1, wherein the polymeric substrate with the ultraviolet or electron beam curable ink or varnish cured thereon meets at least one of the following criteria:
withstands a printed face friction test for at least 30% more cold friction test cycles measured according to ASTM D5264 than the polyethylene-based film without the ultraviolet or electron beam curable ink or varnish cured thereon; or
a chemical resistance to withstand direct contact with one or more of soybean oil, ethyl alcohol at 50% concentration in water or polyoxyethylene (9) nonylphenylether in an immersion test for 24 hours.

7. A stand-up pouch comprising the multilayer structure of claim 1.

8. A stand-up pouch, comprising:
a plurality of panels, each panel being sealed to another panel and comprising:
a polymeric substrate; and
an external layer of ultraviolet or electron beam curable ink or varnish cured on a surface of the polymeric substrate,
wherein the polymeric substrate with the ultraviolet or electron beam curable ink or varnish cured thereon meets at least one of the following criteria:
a thermal surface resistance such that when sealing bars are applied to the polyethylene-based polymeric film in cycles of sealing of no more than 2 seconds and at a temperature corresponding to the melting temperature of the polymeric substrate, the sealing bars remain free of polymer;
withstands a printed face friction test for at least 30% more cold friction test cycles measured according to ASTM D5264 than the polymeric substrate without the ultraviolet or electron beam curable ink or varnish cured thereon; or
a chemical resistance to withstand direct contact with one or more of soybean oil, ethyl alcohol at 50% concentration in water or polyoxyethylene (9) nonylphenylether in an immersion test for 24 hours.

9. The stand-up pouch of claim 8, wherein the cured ultraviolet or electron beam curable ink or varnish has a degree of elongation showing a visible crack upon not less than 10% elongation of the multilayer structure.

10. The stand-up pouch of claim 8, wherein the cured ultraviolet or electron beam curable ink or varnish has a degree of elongation showing a visible crack at less than 10% elongation of the multilayer structure.

11. The stand-up pouch of claim 8, wherein a cured ultraviolet or electron beam curable varnish is applied over a water-based or solvent-based ink.

12. The stand-up pouch of claim 8, the ultraviolet or electron beam curable ink or varnish is applied at least to the sealing regions of the multilayer structure.

13. The stand-up pouch of claim 8, wherein the polymeric substrate is formed from a single material selected from polyethylene, polypropylene, polyester, polyamide, or ethylene vinyl alcohol copolymer.

14. The stand-up pouch of claim 8, wherein the stand-up pouch comprises at least 70 wt % of at least one polyethylene, and no more than 30 wt % of at least one polypropylene.

15. The stand-up pouch of claim 8, wherein the stand-up pouch comprises at least 70 wt % of at least one polypropylene, and no more than 30 wt % of at least one polyethylene.

16. The stand-up pouch of claim 8, wherein the stand-up pouch comprises at least 90 wt % of at least one polyethylene, and no more than 10 wt % of at least one ethylene vinyl alcohol in a distinct barrier layer.

17. The stand-up pouch of claim 8, wherein the polymeric substrate comprises at least two layers co-extruded together.

18. The stand-up pouch of claim 8, wherein the polymeric substrate comprises at least two layers are laminated together.

19. The stand-up pouch of claim 8, wherein the at least a portion of the polyethylene-based polymeric film exhibits a biobased carbon content as determined by ASTM D6866-18 Method B of at least 50%.

20. The stand-up pouch of claim 8, wherein the multilayer structure has Impact Resistance by a Free-Falling Dart Method, measured according to ASTM D1709-01, of greater than 80 gf.

21. A method of forming a multilayer structure, comprising:
forming a polyethylene-based polymeric film comprising:
a sealing layer;
at least one middle layer; and
a printing layer;
applying an ultraviolet or electron beam curable ink or varnish onto the printing layer; and
irradiating the ultraviolet or electron beam curable ink or varnish with ultraviolet or electron beam radiation to form the multilayer structure of claim 1.

22. The method of claim 21, further comprising:
sealing a portion of the sealing layer of the polyethylene-based polymeric film to the sealing layer of another polyethylene-based polymeric film to form a stand-up pouch.

23. A method of forming a stand-up pouch, comprising:
applying an ultraviolet or electron beam curable ink or varnish onto a polymeric substrate;
irradiating the ultraviolet or electron beam curable ink or varnish with ultraviolet or electron beam radiation to form a multilayer structure; and
sealing the multilayer structure to at least one other multilayer structure to form the stand-up pouch of claim 8.

24. The method of any of claim 23, wherein the irradiating comprising irradiating with electron beam radiation that has an intensity of 20 kGv to 100 kGv.
